(19) United States
(12) Patent Application Publication
(10) Pub. No.: US 2007/0067293 A1
(43) Pub. Date: Mar. 22, 2007

(54) System and methods for automatically identifying answerable questions

(76) Inventor: Hong Yu, Bronx, NY (US)

Correspondence Address: BAKER & BOTTS L.L.P., 30 ROCKEFELLER PLAZA, 44TH FLOOR, NEW YORK, NY, 10112-4498, US

(21) Appl. No.: 11/479,645

(22) Filed: Jun. 30, 2006

Related U.S. Application Data
(60) Provisional application No. 60/695,515, filed on Jun. 30, 2005.

(51) Int. Cl. G06F 7/00

(52) U.S. Cl. 707/7

(57) ABSTRACT

A system and method for classifying questions in an information retrieval system as answerable and unanswerable. A model is provided on a machine-learning system derived from a training set of questions A test question is provided for classification, and the test question is classified as answerable or unanswerable by application of said model to said test question. In order to enhance accuracy and robustness of the system, a class-based smoothing technique is provided which maps phrases to domain-specific concepts and semantic types.

### CROSS REFERENCE TO RELATED APPLICATIONS

This application claims the benefit of U.S. Provisional Patent Application Ser. No. 60/695,515, filed on Jun. 30, 2005, entitled “Automatically Identifying Answerable Questions,” which is hereby incorporated by reference in its entirety herein.

### BACKGROUND OF THE INVENTION

1. Field of the Invention

This invention relates to a system and methods for information retrieval, natural language processing, and classifying questions posed in an information retrieval system as answerable and unanswerable

2. Background

Automatic question answering (QA) is an advanced form of information retrieval in which focused answers are generated for either user queries, e.g., a key word search, or ad hoc questions, e.g., questions in a natural language format (for example, “what is X?”, “what is the drug of choice for disease x?”). Most research and development in the area is in the context of open-domain, collection-based, or web based QA. Technologies have been developed for generating short answers to factual questions (e.g., “Who is the president of the United States?”), in part due to work by the Text Retrieval Conference (TREe) QA track (see, e.g., http://trec.nist.gov/). Recently, the Advanced Research and Development Activity (ARDA)'s Advanced Question & Answering for Intelligence (AQUAINT) program (see, e.g., http://www.informedia.cs.cnu.edu/aquaint/) has supported QA techniques that generate long answers for scenario questions (e.g., opinion questions such as “What does X think about Y?” (see, Yu and Hatzivassiloglou, “Towards Answering Opinion Questions: Separating Facts From Opinions and Identifying the Polarity of Opinion Sentences, EMNLP, 2003)). Many QA systems leverage techniques from several fields including “information retrieval” (Rigsbergen, Information Retrieval, 2nd Edition. Butterworths, London, 1979), which may generate query terms relevant to a question and selects documents that are likely candidates to contain answers; information extraction, which may locate portions of a document (e.g., phrases, sentences, or paragraphs) that contain the specific answers; and summarization and natural language generation, which are used to generate coherent, readable answers.

Recently there has been growing interest in domain-specific QA. Exemplary domains include, for example, medicine, genetics, biology, physics, engineering, statistics, finance, accounting, etc. Domain-specific QA can differ from open-domain QA in at least two ways. For one, it might be possible to have a list of question types that are likely to occur, and separate answer strategies might be developed for each one. Secondly, domain-specific resources such as knowledge bases and tools exist with a level of detail that may allow a deeper processing of questions than is possible for open-domain questions.

The QA process may include identifying a user's intentions, and then attempting to retrieve a useful answer. Previously, studies have proposed models to offer explanations when questions posed by users resulted in failed queries or the results of the queries were labeled “unknown” (see, e.g., Chalupsky, H. and T. A. Russ. 2002. “WhyNot: Debugging Failed Queries in Large Knowledge Bases,” Proceedings of the Fourteenth Innovative Applications of Artificial Intelligence, pp. 870-877, 2002 (hereinafter “Chalupsky 2002”), which is incorporated by reference in its entirety herein). According to Chapulsky 2002, when an attempted answer retrieval resulted in a “failed query” result, the QA system would further evaluate the question. For example, if the question was not related to the medical domain, the system would return the question to the user and provide an explanation that the system only handles medical questions. If the question was considered ambiguous (e.g., “What is causing her hives?”), the system would provide disambiguation to generate a list of non-ambiguous questions, from which the user would be able to identify one or more as his/her intentions.

Chalupsky 2002 propose to provide a list of plausible answers or explanations when the exact answers cannot be found in the database by a user query. Possible explanations include missing knowledge, limitations of resources, user misconceptions, and bugs in the system. Chalupsky 2002 have created a system called WhyNot, which accepts queries to the general knowledge base Cyc, and attempts to provide “partial proofs” for failed queries. WhyNot was built on a relational database, in which the information is already “structured” and the data can be readily understood by a computer, and does not handle ad hoc questions, which cannot be processed directly by the computer because they are “unstructured.”

Harabagiu (Harabagiu, S. M. et al., “Intentions, Implicatures and Processing of Complex Questions,” HLT-NAACL Workshop on Pragmatics of Question Answering, 2004, hereinafter “Harabagiu 2004”) have described methods to combine semantic and syntactic features for identifying a user's intentions. For example, if a user asks “Will Prime Minister Mori survive the crisis?”, the method detects the user's belief that the position of the Prime Minister is in jeopardy, since the concept DANGER is associated with the words “survive” and “crisis.” This work derives intentions only from the questions, and do not involve human-computer dialogue. Harabagiu 2004 operates from the premise that all questions are answerable, and does not look into knowledge beyond the lexical-syntactic features of the questions.

All of these above-described techniques assume that all questions can be answered. However, no corpora or database, no matter how large, can incorporate the entire universe of knowledge, and will not contain answers to certain questions. Accordingly, there is a need in the art for a system which can determine whether a question is “answerable” prior to expending resources to retrieve an answer, and which overcomes the limitations of the prior art.

### SUMMARY

It is an object of the present invention to provide categorization or classification of questions as “answerable” and “unanswerable” to make efficient use of information retrieval resources. Questions that are considered “unanswerable” can be referred back to the questioner for reformulation, rather than wasting resources to retrieve answers where the likelihood of a failed query may be significant.

It is a further object of the invention to enhance accuracy of the categorization by applying an optional domain-specific, class-based smoothing technique to compensate for sparse words in the training sets and provide a more accurate and robust system.

These and other objects of the invention, which will become apparent with reference to the disclosure herein, are accomplished by a system and method for classifying questions in an information retrieval system comprising providing a model on a machine-learning system derived from a training set of questions, providing a test question for classification, and classifying said test question as one of answerable and unanswerable by application of said model to said test question.

According to an exemplary embodiment, classifying said test questions comprises utilizing a machine-learning technique. In an exemplary embodiment, the machine learning technique may be a Rocchio/TF*IDF technique, a K-nearest neighbor technique, a naive Bayes technique, a Probabilistic Indexing technique, a Maximum Entropy technique, a Support Vector Machine technique, or a BINS technique.

A method for classifying questions in an information retrieval system is also provided, comprising providing a training set of questions classified as one of answerable and unanswerable, defining a model on a machine-learning system derived from said training set of questions, providing a test question for classification; and classifying said test question as one of answerable and unanswerable by application of said model to said test question.

In an exemplary embodiment, defining a model on a machine-learning system derived from said training set of questions comprises utilizing a machine-learning technique. In some embodiments, defining a model on a machine-learning system derived from said training set of questions may comprise parsing said questions. In some embodiments, defining a model on a machine-learning system comprises utilizing a class-based smoothing. A class-based smoothing step may comprise mapping phrases in said training set into domain-specific concepts. In certain embodiment, a class-based smoothing step may comprise mapping phrases in said training set into domain-specific semantic types. A class-based smoothing step my comprise utilizing the Unified Medical Language System to map phrases in said training set of questions.

A system for classifying questions in an information retrieval system is provided comprising a database comprising a model for a machine-learning system derived from a training set of questions and a server comprising a processor and a memory operatively coupled to the processor, the memory storing program instructions that when executed by the processor, cause the processor to receive a test question from a user and to classify the test question as “answerable” or “unanswerable” by application of the model to the test question.

In certain embodiments, the program instructions comprise a machine-learning program. The memory may store program instructions that when executed by the processor, cause the processor to receive a training set of questions classified as one of answerable and unanswerable. In some embodiments, the memory may store program instructions that when executed by the processor, cause the processor to define a model derived from said training set of questions;

In accordance with the invention, the object of providing a system and method for categorizing questions as “answerable” and “unanswerable” has been met. Further features of the invention, its nature and various advantages will be apparent from the accompanying drawings and the following detailed description of illustrative embodiments.

### BRIEF DESCRIPTION OF THE DRAWINGS

FIG. 1 is a diagram illustrating the system in accordance with the present invention.

FIGS. 2-3 illustrate a flowchart illustrating an exemplary workflow for automatically categorizing questions in accordance with the present invention.

FIG. 4 illustrates a technique for categorizing questions.

While the subject invention will now be described in detail with reference to the figures, it is done so in connection with the illustrative embodiments.

### DETAILED DESCRIPTION OF EXEMPLARY EMBODIMENTS

This invention will be further understood in view of the following detailed description of exemplary embodiments of the present invention.

A technique and system for filtering questions is described herein that determines whether or not a posed question is “answerable.” A question may considered “answerable” if the question can be answered with evidence, as will be discussed in greater detail hereinbelow. A question may be considered “unanswerable” if the question may not be answered with evidence, e.g., the question is unrelated to a specific domain or is to specific to the subject of the question. In an exemplary embodiment, the evidence may refer to medical evidence. In the medical domain, physicians are urged to practice “evidence-based medicine” when faced with questions about how to care for their patients. Evidence-based medicine refers to the use of best evidence from scientific and medical research to make decisions about the care of individual patients. The need for evidence based medicine have also driven the biomedical researchers to provide evidence in their research reports.

Although the exemplary embodiment is described in the context of medical diagnostic questions, it is understood that the techniques described are useful in any context in which it is desired to determine whether an answer may be automatically determined for any question posed. For example, and without limitation, the techniques described herein are useful in medical, psychological, therapeutic, statistical, engineering, managerial, financial, or business context.

A training set of questions is used to train the system using supervised machine-learning algorithms. (The training questions and the test questions (to be discussed below) may be ad hoc questions in a natural language format, or alternatively structured questions in a relational database.) Each question in the training set is annotated or classified as “answerable” or “unanswerable.” In the exemplary embodiment, 200 clinical questions were used that have been annotated by physicians to be “answerable” or “unanswerable.” The supervised machine-learning algorithms are then used to automatically classify questions into one of these two categories. The machine-learning algorithms may be optionally supplemented by the use of domain specific terminology and classification features, as will be described in greater detail below. In the exemplary embodiment, semantic features from a large biomedical knowledge terminology, such as the Unified Medical Language System (“UMLS”) are incorporated into the classification system. Many search engines will ignore common words, e.g., “of,” “if,” “what,” etc., also referred to as “stop words,” when conducting searches. However, the technique and system herein incorporates stop words into its classification analysis, as will be described below, which has been found to be useful for separating “answerable” from “unanswerable.” Following the categorization into “answerable” and “unanswerable,” the “answerable” questions may then be further processed for answer extraction and generation; and the “unanswerable” questions may be further analyzed to determine the user's intentions.

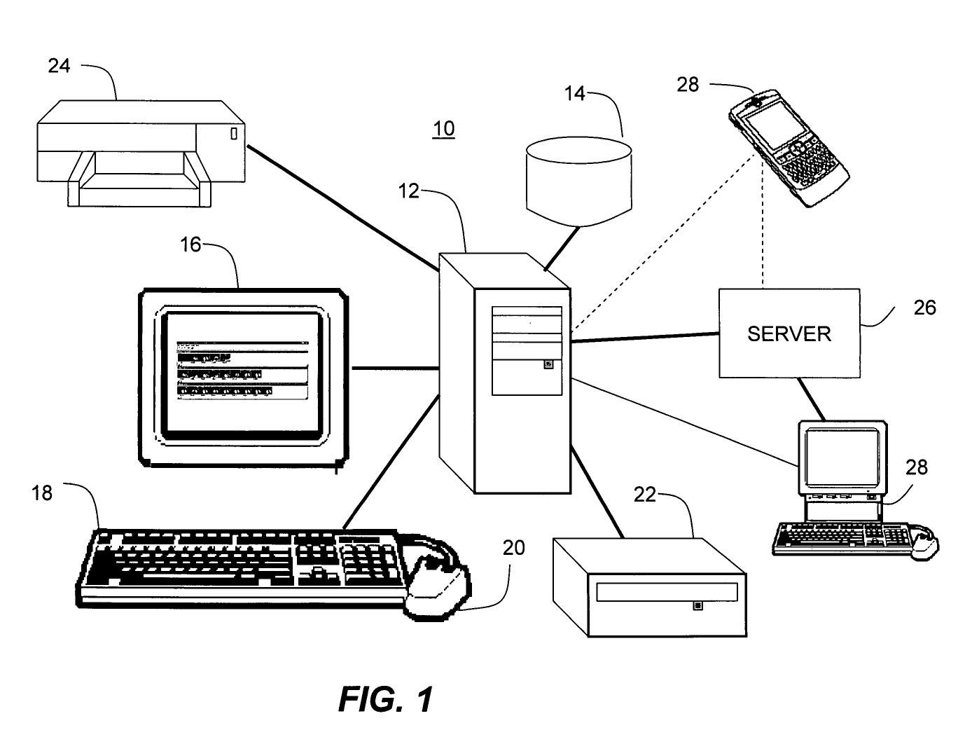

An exemplary embodiment of a system 10 for carrying out the techniques described herein is illustrated in FIG. 1. System 10 includes a processor, such CPU 12, which may be any appropriate personal computer, or distributed computer system including a server and a client. For example, a computer useful for this system is an Apple® Macintosh® PowerPC (dual 2 GHz CPU, 2 GB of physical memory, Mac OSX server 10.4.2). A memory unit 14, such as a disk drive, flash memory, volatile memory, etc., may be used to store the training data, the questions to be categorized, the machine-learning module or other expert systems, the user interface software, and any other software which may be loaded onto the CPU 12 for evaluating the questions to be categorized in accordance with the exemplary embodiment of the invention. Also provided may be user interface equipment, including a monitor 16 and an input device such as a keyboard 18 and a mouse 20. The training data may be inputted by keyboard 18 or an input/output device 22, such as a disk drive, tape drive, CD-ROM drive or other data input equipment. The resulting data may be outputted to the input/output device 22, displayed on the monitor 16, or printed to a printer 24. The processing functions may be distributed over a network, e.g., a WAN or LAN network, or the Internet to one or more additional servers 26. Input and/or access may be achieved from multiple workstations 28, e.g., personal computers, mobile devices, etc., connected directly, indirectly, or wirelessly (as indicated by the dashed line) to the server 26 or CPU 12.

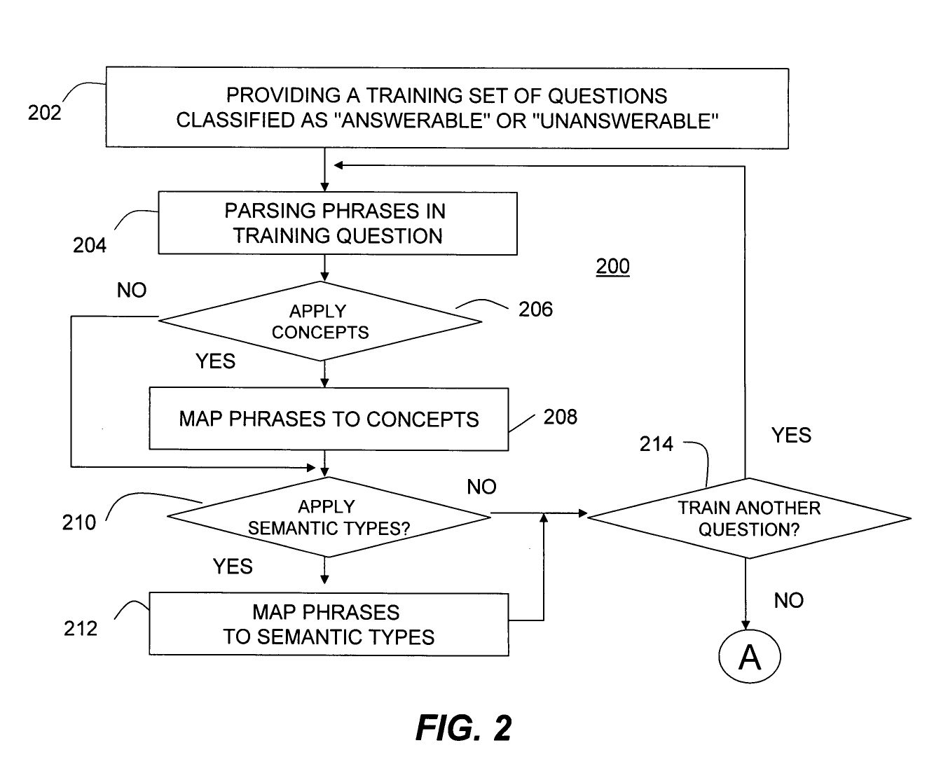

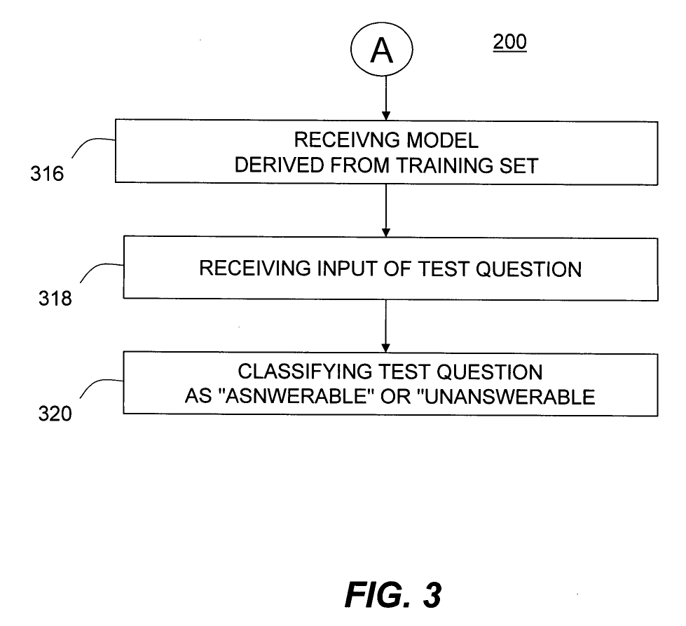

An exemplary technique for categorizing questions is illustrated in FIGS. 2 and 3, and may include developing a training set of questions (step 202), e.g., a set of questions that are previously categorized as either “answerable” or “unanswerable.” Typical questions are available from several sources. For example, in the context of a physician interview with a patient, Ely (see, Ely et al., “Obstacles to Answering Doctor's Questions About Patient Care With Evidence: Qualitative Study,” BMJ 321:429-432, 2002 and Ely et al., “Analysis of Questions Asked by Family Doctors Regarding Patient Care,” BMJ 319:358-361, 1999, which are incorporated by reference in their entireties therein) collected thousands of clinical questions from more than one hundred family doctors. They excluded requests for facts that could be obtained from the patient's medical records (e.g., “What was the patient's blood potassium concentration?”) or from the patient himself (e.g., “How long have you been coughing?”). Ely identified obstacles that prevent physicians from finding answers to some of those questions The National Library of Medicine has made available a total of 4,653 clinical questions (see, e.g., http://clinques.nlm.nih.gov/JitSearch.html) over different studies (Alper et al. 2001, D'Alessandro et al. 2004, Ely et al. 1999, Ely et al. 2000, Gorman et al. 1994, Niu et al. 2003).

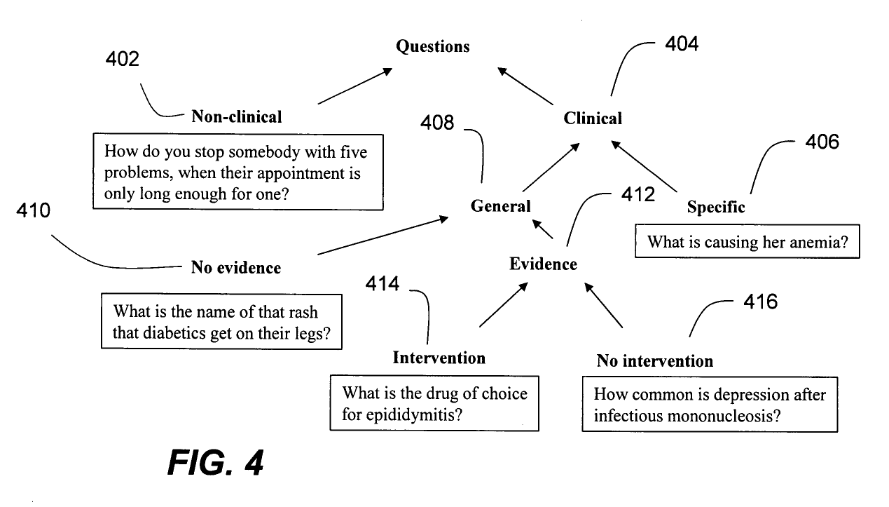

In an exemplary embodiment, the training set used a plurality of clinical questions which have been placed into one of five categories by Ely, as described hereinabove. Two hundred training questions were randomly selected from the questions that were collected. After searching for answers to these questions in biomedical literature and online medical databases, As illustrated in FIG. 4, questions were categorized as “non-clinical” 402 or “clinical” 404. The “clinical” 404 questions were further classified as “specific” 406 or “general” 408. The “general” 408 questions were subdivided into “evidence” 412 and “no evidence” 410. The “evidence” 412 questions were further classified into “intervention” 414 or “no intervention” 412. According to this categorization, “non-clinical” 402, “specific” 406, “no-evidence” 410, “intervention” 414 and “no-intervention” 416 categories are “leaf-nodes.”

For purposes of the techniques described herein, “non-clinical” 402, “specific” 406, and “no evidence” 410 questions are considered “unanswerable.” (It is understood that different categorizations can be used to classify questions as “unanswerable.”) “Non-clinical” questions are those question that do not deal with the specific domain being considered. For example, “How do you stop somebody with five problems, when their appointment is only long enough for one?” is a non-clinical question. “Specific” questions require information from a patient's record. An exemplary “specific” question is “What is causing her anemia?” “No-evidence” questions are those questions for which the answer is generally unknown. For example, “What is the name of the rash that diabetics get on their legs?” The categories of “evidence” (i.e., “intervention” 414 and “no-intervention” 416 questions) are considered potentially “answerable” with evidence. An exemplary “intervention” 414 question is “What is the drug of choice for treating epididymitis?” which implies a subsequent action or treatment by the physician. A “non-intervention” 416 question may be “How common is depression after infectious mononucleosis?” In the exemplary embodiment, a total of 83 “unanswerable” questions and 117 “answerable” questions were gathered. These 200 training questions were used to automatically classify a question as either “answerable” or “unanswerable.”

In another exemplary embodiment, questions may be categorized according to a taxonomy which categories questions as “evidence” or “no evidence.” According to such taxonomy. “Evidence” questions may be considered “answerable,” and “no evidence” questions may be considered “unanswerable.”

Another step in the process is to use machine-learning tools to train on the annotated “answerable” and “unanswerable” training questions (steps 204-214). The trained machine-learning classifiers may then provided to the computer system (step 316) used to predict whether an additional test question is either “answerable” or “unanswerable.” (A test question is generally understood herein to refer to a question other than an annotated or previously classified question, in which the user desires to obtain a predicted classification.) In particular, the system receives an input of a test question (step 318) and classifies the test question as “answerable” or unanswerable.” The machine-learning tools automatically learn statistical patterns of words that appear in “answerable” and “unanswerable” questions and then apply those patterns for prediction. Several exemplary text categorization systems are described herein. For example, several systems comprise the publicly available “Rainbow” package (see, McCallum, A., “A Toolkit for Statistical Language Modeling, Text Retrieval, Classification, and Clustering,” http://www.cs.cmu.edu/˜mccallum/bow, 1996, which is incorporated by reference in its entirety herein). Another tool is “libsvm” which is an implemented tool of the Department of Computer Science of National Taiwan University, which may be downloaded at http://www.csie.nut.edu.tw/˜cjlin/libsvmtools/. The approaches used by these exemplary systems are, for example, RocchioITF*IDF, K-nearest neighbors (“kNN”), maximum entropy, probabilistic indexing, and naïve Bayes. Each of these machine-learning algorithms are well known in the art (see, e.g., Sable, C. Robust Statistical Techniques for the Categorization of Images Using Associated Text, Columbia University, 2003 which is incorporated by reference in its entirety herein).

According to one exemplary embodiment, a Rocchio/TF*IDF system (Rocchio, J., “Relevance Feedback in Information Retrieval, in The Smart Retrieval System: Experiments in Automatic Document Processing, pp. 313-322, Prentice Hall, 1971 which is incorporated by reference in its entirety herein) is used, which adopts TF*IDF, the vector space model typically used for information retrieval, for text categorization tasks. RocchioITF*IDF represents every document and category as a normalized vector of TF*IDF values. The term frequency (TF) of a token (typically a word) is the number of times that the token appears in the document or category, and the inverse document frequency (IDF) of a token is a measure of the token's rarity (usually calculated based on the training set).

For test questions, scores are assigned to each potential category by computing the similarity between the question to be labeled and the category, often computed to be the cosine measure between the question vector and the category vector, such that the category with the highest score is then chosen.

According to another exemplary embodiment, a K-nearest neighbors system (“kNN”) (see, e.g., Sebastiani, F., “Machine Learning in Automated Text Categorization,” ACM Computing 2002, Yang and Liu 1999) determines which training questions are the most similar to each test question, and then uses the known labels of these similar training questions to predict a label for the test question. The similarity between two questions can be computed as the number of overlapping features between them, as the inverse of the Euclidean Distance between feature vectors, or according to some other measure well known in the art.

The naïve Bayes approach is used in another exemplary embodiment for machine-learning and text categorization. Naïve Bayes is based on Bayes' Law and assumes conditional independence of features. For text categorization, this “naïve” assumption amounts to the assumption that the probability of seeing one word in a question is independent of the probability of seeing any other word in a question, given a specific category. The label of a question is the category that has the highest probability given the “bag of words” in the document. To be computationally plausible, log likelihood is generally maximized instead of probability.

Probabilistic Indexing is another probabilistic approach that chooses the category with the maximum probability given the words in a question, as used in another exemplary embodiment. Probabilistic indexing is described in Fuhr, N., “Models for Retrieval with Probabilistic Indexing,” Information Processing and Management, 25(1):55-72, 1998, which is incorporated by reference in its entirety herein. Unlike Naïve Bayes, the number of times that a word occurs in a question is considered, because the probability of choosing each specific word, if a word were to be randomly selected from the test question, is used in the probabilistic calculation.

Maximum Entropy is another probabilistic approach that has been applied to text categorization (see, Nigam, K. et. al., “Using Maximum Entropy for Text Classification,” Proceedings of the IJCAI-99 Workshop on Natural Language Processing, 1999) in accordance with another yet exemplary embodiment. A Maximum Entropy system starts with the initial assumption that all categories are equally likely. It then iterates through a process known as improved iterative scaling that updates the estimated probabilities until a stopping criterion is met. After the process is complete, the category with the highest probability is selected.

A support vector machine (“SVM”) system is incorporated in another exemplary embodiment (see, e.g., Zhang and Lee, “Question Classification Using Support Vector Machines,” Proceedings of the 26th Annual International ACM SIGIR Conference, pp. 26-32, 2003, which is incorporated by reference in its entirety herein.). SVMs act as a binary classifier that learns a hyperplane in a feature space that acts as an optimal linear separator which separates (or nearly separates) a set of positive examples from a set of negative examples with the maximum possible margin (the margin is defined as the distance from the hyperplane to the closest of the positive and negative examples).

Another exemplary embodiment uses the BINS technique (see, Sable, C. and Church, K., “Using BINS to Empirically Estimate Term Weights for Text Categorization,” EMNLP, Pittsburgh, 2001 incorporated by reference in its entirety herein), a generalization of Naïve Bayes. BINS places words that share common features into a single bin. Estimated probabilities of a token appearing in a question of a specific category are then calculated for bins instead of individual words, and this acts as a method of smoothing which can be especially important for small data sets.

An additional optional step in the process is to incorporate a technique of class-based smoothing, such incorporating concepts and semantic types from a domain specific knowledge resource, such as the UMLS (steps 204-212). Class-based smoothing refers to the feature in which the probabilities of individual or sparse words are smoothed by the probabilities of larger or less sparse semantic classes. Class based smoothing is discussed in Resnick, P., “Selection and Information: A Class-Based Approach to Lexical Relationships, Ph. D. Thesis, Department of Computer and Information Science, University of Pennsylvania, 1993, which is incorporated by reference in its entirety herein. In another exemplary embodiment, WordNet, an ontology for general English, can be used in substantially the same manner in an open-domain context.

The UMLS (see http://www.nlm.nih.gov/research/links; see also Humphreys and Lindberg, “The UMLS Project: Making the Conceptual Connection Between the Users and the Information They Need,” Bull Med Libr Assoc 81: 170-7,1993 incorporated by reference in their entirety herein) includes the Metathesaurus, a large database that incorporates more than one million biomedical concepts, synonyms, and concept relations. For example, the UMLS links the following synonymous terms as a single concept: Achondroplasia, Chondrodystrophia, Chondrodystrophia fetalis, and Osteosclerosis congenita.

The UMLS also consists of the Semantic Network, which contains 135 semantic types. Each semantic type represents a more general category to which certain specific UMLS concepts can be mapped via “is-a” relationships (e.g., Pharmacologic Substance). The Semantic Network also describes a total of 54 types of semantic relationships (e.g., hierarchical is-a and part-of relationships). Each specific UMLS concept in the Metathesaurus is assigned one or more semantic types. For example, Arthritis is assigned to one semantic type, Disease or Syndrome; Achondroplasia is assigned to two semantic types, Disease or Syndrome and Congenital Abnormality.

The National Library of Medicine makes available MMTx (see http://mmtx.nlm.noh.gov), a programming implementation of MetaMap (see Aronson, “Effective Mapping of Biomedical Text to the UMLS Metathesaurus: The MetaMap Program,” American Medical Information Association, 2001 incorporated by reference in its entirety herein), which maps free text to UMLS concepts and their associated semantic types. The MMTx program first parses text, separating the text into noun phrases (step 204). It understood that other parsing techniques may be used. If desired by the user (step 206), each noun phrase may then be mapped to a set of possible UMLS concepts (step 308), taking into account spelling and morphological variations, and each concept is weighted, with the highest weight representing the most likely mapped concept. If desired by the user (step 210), the UMLS concepts are then mapped to semantic types according to definitive rules as described above (step 212). MMTx can be used either as a standalone application or as an API that allows systems to incorporate its functionality. In an exemplary embodiment, MMTx has been utilized to map terms in a question to appropriate UMLS concepts and semantic types. The resulting concepts and semantic types are additional features for question classification. As indicated by step 214, the process continues until all training questions are used to generate the model.

### EXAMPLE

Several previously labeled questions are presented for training machine-learning system:
How to understand her problem? (Unanswerable) [1a]
How to treat her arthritis? (Answerable) [1b]

In an exemplary embodiment, the “bag of words” approach is used, such that every word in a question is considered an independent predictor of the question class (step 204). It is understood that other parsing techniques may be used. Machine-learning tools then learn that if the words “understand” and “problem,” appear in a question, the question is “unanswerable.” On the other hand, if the words “treat” and “arthritis” appear in a question, then the question is “answerable.” Those patterns that are learned to predict the question such as “What are the causes of arthritis?” to be “answerable” because of the word “arthritis.”

### EXAMPLE

A test question is presented for classification, which may include terms that have not previously appeared in the training set:
What are the causes of congestive heart failure (CHF)? [2]
   A machine-learning system which trained on questions such as [1a] and [1b], above, may not be able to predict the class of the above-listed question because no learned words appear in the question. In order to address this potential limitation, domain specific semantic types may be applied in this case. In the exemplary embodiment, UMLS semantic types may be applied by using the tool MMTx, as discussed above.

UMLS maps both “arthritis” and “CHF” to “disease or syndrome.” Accordingly, the machine-learning tools would be able to be robust and generalizable to predict the label of the question “What are the causes of CHF?” based on the question “How to treat arthritis?” If words or phrases in a question have mapped to semantic types, the semantic types are added as additional learning features for machine-learning.

The question “How to treat arthritis” is transformed to “How to treat arthritis disease_or_syndrome” via MMTx. Consequently, domain-specific concepts may be integrated into the “bag of words” by adding the UMLS concepts to the end of the question. The results, as will be described below, show that incorporating semantic features in general enhance the performance of question classification to achieve about 80% accuracy. The analysis also shows that stop words play an important role for separating “answerable” from “unanswerable.”

Evaluation

To evaluate the performance of each system, a four-fold cross-validation was performed. Specifically, the corpus was randomly divided into four subsets of 50 questions each for four-fold cross-validation experiments; i.e., each machine-learning tool discussed in the exemplary embodiments above is trained on 150 questions and tested on the other 50. These experiments are performed using bag of words alone as well as bag of words plus combinations of the other features discussed in the previous subsection, UMLS concepts and semantics.

Results are reported herein according to two metrics. The first metric is overall accuracy, which is the percentage of questions that are categorized correctly (i.e., they are correctly labeled as “answerable” or “unanswerable”). In comparison, a simple baseline system that automatically categorizes all questions as “answerable” (something that most automatic QA systems assume) would achieve an overall accuracy of 117/200=58.5%.

The second evaluation metric is the F1 measure (see, e.g., Rigsbergen, V., Information Retrieval, 2nd Edition. Butterworths, London, 1979) for the “answerable” category. The F1 measure combines the precision (P) for the category (e.g., the number of documents correctly placed in the category divided by the total number of document placed in the category) with the recall (R) for the category (e.g., the number of documents correctly placed in the category divided by the number of documents that actually belong to the category). The metric is calculated as
F1=(2*P*R)/(P+R)
The result is always in between the precision and the recall but closer to the lower of the two, thus requiring a good precision and recall in order to achieve a good F1 measure.

In the exemplary embodiments, MMTx is applied for identifying appropriate UMLS concepts and semantic types for each question, which are then included as features for question classification. The precision of MMTx has also been evaluated for this task. A manual examination of the 200 questions comprising the corpus was performed, in which MMTx assigns 769 UMLS Concepts and 924 semantic types to the 200 questions (Some UMLS concepts are mapped to more than one semantic type, as discussed above). The validation analysis has indicated that 164 of the UMLS Concept labels and 194 of the semantic type labels were wrong; this indicates precisions of 78.7% and 79.0%, respectively.

The performance of the machine-learning systems used to label questions as “answerable” or “unanswerable” with feature combinations such as class-based smoothing via UMLS and MMTx. Table 1 shows the results of all systems tested using the cross-validation procedure. The percentages for overall accuracy and F1 scores (in parentheses) of machine-learning systems with different combinations of learning features for classifying “answerable” versus “unanswerable” biomedical questions. The features which are used are designated with “C” for UMLS concepts, and “ST” refers to semantic types. (The denotation “*” indicates “Rainbow” implementation discussed above, and the denotation “**” indicates libsvm implementation.) With each feature combination, the system that achieves the best performance was determined to be the Probabilistic Indexing system; the overall accuracy is as high as 80.5% and the F1 measure for the “answerable” category is as high as 83.0%. All of the exemplary embodiments discussed herein outperform the simple baseline system that automatically categorizes all questions as “answerable.”

TABLE 1

| ML Approach | Bag of Words | Words + C | Words + ST | Words + C + ST | C only | ST only |
|---|---|---|---|---|---|---|
| *Rocchio/TF*IDF | 74.0 (77.4) | 72.5 (75.8) | 74.5 (77.5) | 74.0 (77.2) | 67.6 (70.3) | 65.0 (68.5) |
| *kNN | 68.5 (71.7) | 69.0 (73.5) | 65.5 (69.9) | 65.5 (70.1) | 65.0 (66.0) | 61.5 (61.6) |
| *MaxEnt | 66.0 (69.6) | 68.0 (73.1) | 70.5 (76.1) | 69.5 (74.9) | 65.0 (67.6) | 65.5 (70.9) |
| *Prob Indexing | 78.0 (81.7) | 80.5 (83.0) | 80.0 (82.9) | 79.0 (82.1) | 70.0 (70.8) | 66.5 (70.0) |
| **SVMs | 68.0 (71.9) | 70.5 (73.3) | 70.5 (74.9) | 72.5 (75.8) | 62.5 (70.1) | 67.0 (69.8) |
| *Naïve Bayes | 68.0 (74.8) | 74.5 (77.9) | 73.5 (77.6) | 73.0 (76.7) | 71.0 (76.0) | 64.0 (69.2) |
| Bins | 72.0 (74.5) | 72.0 (75.2) | 68.5 (72.2) | 66.5 (69.1) | 66.0 (70.7) | 58.5 (64.4) |

In order to examine useful features for the classification, log likelihood ratios of words in the questions of the two categories (i.e., “answerable” vs. “unanswerable”) were examined. For each word/category pair, the level of indication of that word for that category is computed as the log likelihood of seeing the word in a question of the specified category minus the log likelihood of seeing the word in the most likely category for the word, not including the given category. Thus, the strength of a word for a category will only be positive if it is the most likely category given the word and the magnitude of the strength will depend on the likelihood of the second place category. For each question, the strength of all words in the question are computed for every category (only one category will have a positive strength for each word), and the top words for each category are displayed.

### EXAMPLE

The individual words in a question are given individual weights.
“How soon should you ambulate a patient with a deep vein thrombosis?” [3]

The top three words determined to be “answerable” and “unanswerable” (the higher the score, the stronger indicating value) are:

TABLE 2
Answerable

| | | |
|---|---|---|
| you (1.8) | should (1.0) | how (0.5) |

Unanswerable

| | | |
|---|---|---|
| a (1.6) | patient (0.2) | with (−0.2) |

The word “with” is computed to have a negative weight, which means that it is an indicator of an “answerable” question. This question contains only two words that are indicative of an “unanswerable” question. The words “ambulate” and “thrombosis” are infrequent and therefore have low scores. According to this exemplary embodiment, the questions was categorized as “answerable.”

It was observed that many stop words have high scores, and therefore it was hypothesized that stop words play an important role for the classification task. Table 3 shows the question classification results (i.e., the increase (+) or decrease (−) of overall accuracy and F1 scores (in parentheses)) when the stop words are removed from the questions. (The symbol “*” indicates Rainbow implementation, discussed hereinabove.) The results of Table 3 show that when stop words are excluded, it has in general significantly decreased performance in all systems, and in particular naïve Bayes and probabilistic indexing. The results conclude that the stop words play an important role for classifying a question posed by a physician into either “answerable” or “unanswerable.”

TABLE 4

| | Performance Including Stop Words | | | |
|---|---|---|---|---|
| | Bag of | | | Words + |
| ML Approach | Words | Words + C | Words + ST | C + ST |
| *RocchioffF | −3.0 (−3.1) | −6.5 (−6.4) | −5.5 (−4.2) | −4.5 (−3.4) |
| *IDF | | | | |
| *kNN | +1.5 (+1.4) | −1.0 (−2.1) | −1.5 (−1.2) | −3.0 (−3.1) |
| *MaxEnt | +0.5 (−2.2) | −7.5 (−7.9) | −2.5 (−1.5) | −2.0 (−0.8) |
| *Prob Indexing | −3.0 (−4.4) | −6.5 (−7.5) | −7.5 (−6.7) | −4.0 (−3.5) |
| *Naïve Bayes | −6.0 (−3.7) | −9.5 (−7.8) | −5.0 (−5.4) | −6.5 (−7.6) |

Based on overall accuracy results, all systems beat random guessing (50.0%) and the simple baseline system in which all questions are automatically categorized as “answerable” (58.5%). Furthermore, the F1 measure for the “answerable” category is higher than the overall accuracy for each system; this indicates that all systems have a slight disposition towards the “answerable” category (based on the training documents). Compared to typical text categorization tasks, the data set is relatively small (only 150 short questions are used for training at one time) which leads to a small feature space. Nevertheless, most systems achieve reasonable performance with several feature combinations, and the probabilistic indexing system achieves and overall accuracy that is 21.5% higher than the simple baseline system.

According to another exemplary embodiment, a system and technique is provided which automatically classifies questions into other specific categories. For example, the questions may be classified according to the categories discussed above relative to Ely: “clinical” 404, “non-clinical” 402, “general” 408, “specific” 406, “evidence” 412, “no-evidence” 410, “intervention” 414, and “no intervention” 416. The techniques for classifying questions into these categories is substantially identical as with the techniques described above for classifying answerable and unanswerable questions, with the differences noted herein. In one embodiment, the questions are classified into binary classes based on the evidence taxonomy; for example “clinical” 404 vs. “non-clinical” 402; “general” 408 vs. “specific” 406; “evidence” 412 vs. “no-evidence” 410 and “intervention” 414 vs. “no intervention” 416 by applying each of the machine-learning systems discussed hereinabove.

As another exemplary embodiment, the machine-learning systems are applied to classify the questions into one of the five “leaf-node” categories of the evidence taxonomy, such as “non-clinical” 402, “specific” 406, “no-evidence” 410, “intervention” 414 and “no-intervention” 416. A “flat” approach may be used, in which each classifier is trained with the training sets consisting of documents with labels for each category; in this case, “non-clinical” 402, “specific” 406, “no-evidence” 410, “intervention” 414 and “no-intervention” 416.

A “ladder” approach may be used in accordance with another embodiment. The ladder performs multi-class categorization (e.g., 5-class categorization in the exemplary embodiment) by combining several independent binary classifications. It first predicts whether a question is “clinical” 404 vs. “non-clinical” 402. If a question is “clinical” 404, it then predicts the question to be “general” 408 vs. “specific” 406. If general, it further predicts to be “evidence” 412 vs. “no evidence” 410. Finally, if “evidence” 412, it classifies the question to be either “intervention” 414 or “no intervention” 416. It is understood that different machine-learning classifiers may be used at different “steps” of the ladder.

Various references are cited herein, the contents of which are hereby incorporated by reference in their entireties.
Allen, J. F. and C. R. Perrault. “Analyzing Intention In Utterances.” In R J. Grosz, K. S. Jones, and B. L. Weber, editors, Readings in Natural Language Processing, Pages 441458. Morgan Kaufmann Publishers, Inc., Los Altos, Calif., 1986.
Alper, B., J. Stevermer, D. White, and B. Ewigman. “Answering Family Physicians' Clinical Questions Using Electronic Medical Databases.” J Fam Pract 50: 960-965, 2001.
Aronson, A. “Effective Mapping of Biomedical Text to the UMLS Metathesaurus: The MetaMap Program.” American Medical Information Association, 2001.
Bergus, G. R., Randall, C. S., Sinift, S. D. and D. M. Rosenthal. “Does The Structure Of Clinical Questions Affect The Outcome Of Curbside Consultations With Specialty Colleagues?” Arch Fam Med. 9(6): 541-7, 2000.
Chalupsky, H. and T. A. Russ. “WhyNot: Debugging Failed Queries in Large Knowledge Bases.” In Proceedings Of The Fourteenth Innovative Applications Of Artificial Intelligence, pages 870-877, AAAI Press, 2002.
D'Alessandro, D. M., Kreiter, C. D., and M. W. Peterson. “An Evaluation Of Information Seeking Behaviors Of General Pediatricians.” Pediatrics 113: 64-69, 2004.
Ely, J., J. Osheroff, M. Ebell, G. Bergus, B. Levy, M. Chambliss, and E. Evans. “Analysis Of Questions Asked By Family Doctors Regarding Patient Care.” BMJI: 358-361, 1999.
Ely, J., J. Osheroff, M. Eben, M. Chambliss, D. Vinson, J. Stevermer, and E. Pifer. “Obstacles To Answering Doctors' Questions About Patient Care With Evidence: Qualitative Study.” BMJ 324: 710-713, 2002.
Ely, J., J. Osheroff, P. Gonnan, M. Ebell, M. Chambliss, E. Pifer, and P. Stavri. “A Taxonomy Of Generic Clinical Questions: Classification Study.” BMJ 321: 429-432, 2000.
Fuhr, N. “Models For Retrieval With Probabilistic Indexing.” Information Processing and Management 25(1):55-72, 1998.
Gaasterland, T., P. Godfrey, and J. Minker. “An Overview Of Cooperative Answering.” In Nonstandard Queries And Nonstandard Answers, pages 1-40, Clarendon Press, 1994.
Gonnan, P., J. Ash, and L. Wykoff. “Can Primary Care Physician's Questions Be Answered Using The Medical Journal Literature?” Bull Med Libr Assoc 82: 140-146, 1994.
Grice, H. “Logic and Conversation.” In Syntax and Semantics, Academic Press, 1975.
Harabagiu, S. M., Maiorano, S. J., Moschitti, A, and C. A. Bejan. “Intentions, Implicatures and Processing of Complex Questions.” In HLT-NAACL Workshop on Pragmatics of Question Answering, 2004.
Hermjakob, U. “Parsing And Question Classification For Question Answering.” In Proceedings of ACL Workshop on Open Domain Question Answering, 2001.
Hovy, E., Gerber, L., Hermjakob, U., Junk, M., and C. Y. Lin. “Question Answering In Webclopedia. In Proceedings of the TREC-9 Conference, 2001.
Hughes, S. “Question Classification in Rule Based Systems.” In Annual Technical Conference of the British Computer Society Specialist Group on Expert Systems, 1986.
Humphreys, B. L., and D. A. Lindberg. “The UMLS Project: Making the Conceptual Connection Between Users and the Information They Need.” Bull Med Libr Assoc 81: 170-7, 1993.
Jacquemart, P., and P. Zweigenbaum. “Towards A Medical Question-Answering System: A Feasibility Study.” Stud Health Technol Inform 95: 463-8, 2003.
Joachims, T. “A Probabilistic Analysis Of The Rocchio Algorithm With TFIDF For Text Categorization.” In Proceedings of the 14th International Conference on Machine Learning, 1997.
Lewis, D. “Naive (Bayes) At Forty: The Independence Assumption In Information Retrieval.” In Proceedings of the European Conference on Machine Learning, 1998.
McCallum, A. “A Toolkit For Statistical Language Modeling, Text Retrieval, Classification, And Clustering.” http://www.cs.cmu.edu/˜mccallumlbow, 1996.
Mosteller, F. and D. Wallace. “Inference in an authorship problem.” Journal of the American Statistical Association 58:275-309, 1963.
Nigam, K.; Lafferty, J., and McCallum, A. “Using Maximum Entropy For Text Classification.” In Proceedings Of The IJCAI-99 Workshop On Machine Learning For Information Filtering, 1999.
Niu, Y., G. Hirst, G. McArthur, and P. Rodriguez-Gianolli. “Answering Clinical Questions With Role Identification.” ACL Workshop On Natural Language Processing In Biomedicine, 2003.
Resnik, P. Selection And Information: A Class-Based Approach To Lexical Relationships. Ph.D. thesis. Department of Computer and Information Science, University of Pennsylvania, 1993.
Rigsbergen, V. Information Retrieval, 2nd Edition. Butterworths, London, 1979.
Rocchio, J. “Relevance Feedback In Information Retrieval.” In The Smart Retrieval System. Experiments in Automatic Document Processing, pages 313-323, Prentice Hall, 1971.
Sable, C. Robust Statistical Techniques for the Categorization of Images Using Associated Text. Columbia University, New York, 2003.
Sable, C., and K. Church. “Using BINS To Empirically Estimate Term Weights For Text Categorization.” EMNLP, Pittsburgh, 2001.
Sackett, D., S. Straus, W. Richardson, W. Rosenberg, and R. Haynes. Evidence-Based Medicine: How To Practice And Teach EBM. Harcourt Publishers Limited, Edinburgh, 2000.
Sebastiani, F. “Machine Learning in Automated Text Categorization.” ACM Computing Surveys. 34: 1-47, 2002.
Straus, S., and D. Sackett. “Bringing Evidence To the Point Of Care.” Journal of the American Medical Association 281: 1171-1172, 1999.
Yang, Y., and X. Liu. “A Re-Examination Of Text Categorization Methods.” In Proceedings in the 22nd Annual International ACM SIGIR Conference on Research and Development in Information Retrieval, 1999.
Yu, H., and V. Hatzivassiloglou. “Towards Answering Opinion Questions: Separating Facts From Opinions and Identifying the Polarity of Opinion Sentences.” EMNLP, 2003.
Yu, H., and C. Sable, and H. R. Zhu. Classifying Medical Questions Based on an Evidence Taxonomy. Forthcoming.
Zhang, D. and Lee, W S. “Question Classification Using Support Vector Machines.” In Proceedings of the 26th Annual International ACM SIGIR Conference, pages 26-32, 2003.

It will be understood that the foregoing is only illustrative of the principles of the invention, and that various modifications can be made by those skilled in the art without departing from the scope and spirit of the invention.

What is claimed is:

1. A method for classifying questions in an information retrieval system comprising:
providing a model for classifying questions on a machine-learning system derived from a training set of questions;
providing a test question for classification; and
classifying said test question as one of answerable and unanswerable by application of said model to said test question.

2. The method as recited in claim 1, wherein classifying said test questions comprises utilizing a machine-learning technique.

3. The method as recited in claim 2, wherein the machine learning technique is a Rocchio/TF*IDF technique.

4. The method as recited in claim 2, wherein the machine learning technique is a K-nearest neighbor technique.

5. The method as recited in claim 2, wherein the machine learning technique is a naive Bayes technique.

6. The method as recited in claim 2, wherein the machine learning technique is a Probabilistic Indexing technique.

7. The method as recited in claim 2, wherein the machine learning technique is a Maximum Entropy technique.

8. The method as recited in claim 2, wherein the machine learning technique is a Support Vector Machine technique.

9. The method as recited in claim 2, wherein the machine learning technique is a BINS technique.

10. The method as recited in claim 1, wherein the question is an ad hoc question.

11. A method for classifying questions in an information retrieval system comprising:
providing a training set of questions classified as one of answerable and unanswerable;
defining a model on a machine-learning system derived from said training set of questions;
providing a test question for classification; and
classifying said test question as one of answerable and unanswerable by application of said model to said test question.

12. The method as recited in claim 11, wherein defining a model on a machine-learning system derived from said training set of questions comprises utilizing a machine-learning technique.

13. The method as recited in claim 11, wherein defining a model on a machine-learning system derived from said training set of questions comprises parsing said questions.

14. The method as recited in claim 11, wherein defining a model on a machine-learning system derived from said training set of questions comprises utilizing a class-based smoothing.

15. The method as recited in claim 14, wherein utilizing a class-based smoothing comprises mapping phrases in said training set into domain-specific concepts.

16. The method as recited in claim 14, wherein utilizing a class-based smoothing comprises mapping phrases in said training set into domain-specific semantic types.

17. The method as recited in claim 14, wherein utilizing a class-based smoothing comprises utilizing the Unified Medical Language System to map phrases in said training set.

18. The method as recited in claim 12, wherein the machine learning technique comprises a Rocchio/TF*IDF technique.

19. The method as recited in claim 12, wherein the machine learning technique is a K-nearest neighbor technique.

20. The method as recited in claim 12, wherein the machine learning technique is a naive Bayes technique.

21. The method as recited in claim 12, wherein the machine learning technique is a Probabilistic Indexing technique.

22. The method as recited in claim 12, wherein the machine learning technique is a Maximum Entropy technique.

23. The method as recited in claim 12, wherein the machine learning technique is a Support Vector Machine technique.

24. The method as recited in claim 12, wherein the machine learning technique is a BINS technique.

25. The method as recited in claim 1, wherein the test question is an ad hoc question.

26. A system for classifying questions in an information retrieval system comprising comprising:
a database comprising a model for a machine-learning system derived from a training set of questions; and
a server comprising a processor and a memory operatively coupled to the processor, the memory storing program instructions that when executed by the processor, cause the processor to receive a test question from a user and to classify said test question as one of answerable and unanswerable by application of said model to said test question.

27. The system as recited in claim 26, wherein the program instructions comprise a machine-learning program.

28. The system as recited in claim 26, wherein the memory storing program instructions that when executed by the processor, cause the processor to receive a training set of questions classified as one of answerable and unanswerable.

29. The system as recited in claim 28, wherein the memory storing program instructions that when executed by the processor, cause the processor to define a model derived from said training set of questions.
